(19) United States
(12) Patent Application Publication
(10) Pub. No.: US 2018/0332339 A1
(43) Pub. Date: Nov. 15, 2018

(54) Set-Top Box with Enhanced Functionality and System and Method for Use of Same

(71) Applicant: Enseo, Inc., Richardson, TX (US)

(72) Inventors: Vanessa Ogle, Fairview, TX (US); Edward H. Wolfe, Plano, TX (US)

(21) Appl. No.: 15/694,096

(22) Filed: Sep. 1, 2017

Related U.S. Application Data
(60) Provisional application No. 62/505,396, filed on May 12, 2017.

(51) Int. Cl. H04N 21/439; H04N 21/214; H04N 21/485; G10L 15/22; G10L 15/18; G10K 11/178

(52) U.S. Cl. CPC H04N 21/4394; H04N 21/2143; H04N 21/4852; G10K 2210/3011; G10L 15/1815; G10K 11/1782; G10L 2015/223; G10L 15/22

(57) ABSTRACT

A set-top box with enhanced functionality and a system and method for use of the same are disclosed. In one embodiment of the set-top box, a housing secures a television input, a television output, a processor, memory, storage, an audio input unit, and an active sound control circuit portion interconnectively therein. The set-top box receives a source signal from an external source and forwards a fully tuned audiovisual signal to a display and speaker based on the source signal. The set-top box utilizes the active sound control circuit portion to generate a processed audio signal by analyzing an external audio signal received at the audio input unit against an internal audio source signal component of the source signal.

### PRIORITY STATEMENT & CROSS-REFERENCE TO RELATED APPLICATIONS

This application claims priority from co-pending United States Patent Application No. 62/505,396, entitled “Set-Top Box with Enhanced Functionality and System and Method for Use of Same” and filed on May 12, 2017, in the names of Vanessa Ogle et al.; which is hereby incorporated by reference for all purposes.

### TECHNICAL FIELD OF THE INVENTION

This invention relates, in general, to set-top boxes and, in particular, to set-top boxes with enhanced functionality and controls and systems and methods for use of the same that address and enhance the content typically received from an external signal source and provided to a television.

### BACKGROUND OF THE INVENTION

Without limiting the scope of the present invention, the background will be described in relation to televisions in the hospitality lodging industry, as an example. To many individuals, a television is more than just a display screen, rather it is a doorway to the world, both real and imaginary, and a way to experience new possibilities and discoveries. Consumers are demanding enhanced content in an easy-to-use platform. As a result of such consumer preferences, the quality of content and ease-of-use are frequent differentiators in determining the experience of guests staying in hospitality lodging establishments. Accordingly, there is a need for improved systems and methods for providing enhanced content in an easy-to-use platform in the hospitality lodging industry.

### SUMMARY OF THE INVENTION

It would be advantageous to achieve a set-top box that would improve upon existing limitations in functionality. It would also be desirable to enable a computer-based electronics and software solution that would provide enhanced content in an easy-to-use platform in the hospitality lodging industry or in another environment. To better address one or more of these concerns, a set-top box with enhanced functionality and controls and a system and method for use of the same are disclosed. In one embodiment of the set-top box, a housing secures a television input, television output, a processor, memory, an audio input unit, an active sound control circuit portion, and a speech processing circuit portion, interconnectively therein.

The set-top box receives a source signal from an external source and forwards a fully tuned audiovisual signal to a display and a speaker based on the source signal. The set-top box utilizes the active sound control circuit portion to generate a processed audio signal by analyzing an external audio signal received at the audio input unit against an internal audio source signal component of the source signal. The processed audio signal may then be analyzed by the speech processing circuit portion to determine the presence of speech including a command. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic diagram depicting one embodiment of a system for providing a set-top box having enhanced functionality and control thereon according to the teachings presented herein;

FIG. 2A is a wall-facing exterior elevation view of one embodiment of the set-top box depicted in FIG. 1 in further detail;

FIG. 2B is a television-facing exterior elevation view of the set-top box depicted in FIG. 2A;

FIG. 2C is a front perspective view of a dongle depicted in FIG. 1 in further detail;

FIG. 3 is a functional block diagram depicting one embodiment of the set-top box presented in FIGS. 2A and 2B;

FIG. 4A is a schematic block diagram depicting one operational embodiment of the set-top box presented in FIG. 1;

FIG. 4B is a schematic block diagram depicting another operational embodiment of the set-top box presented in FIG. 1; and

FIG. 5 is a flow chart depicting one embodiment of a method for providing a set-top box having enhanced functionality and control according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

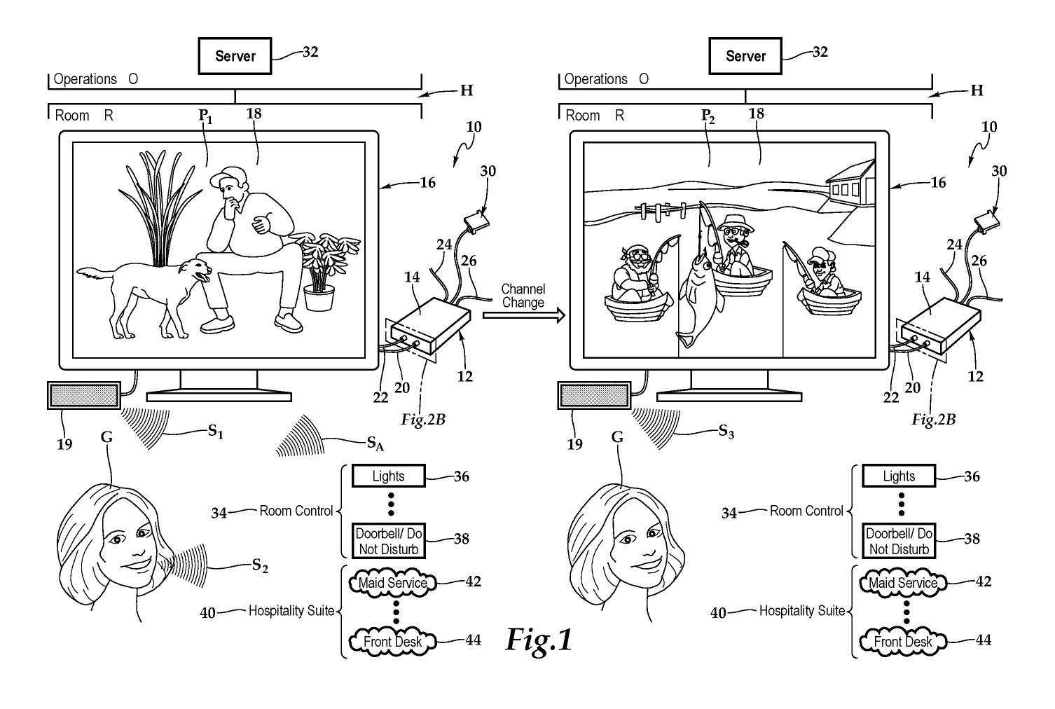

Referring initially to FIG. 1, therein is depicted one embodiment of a system 10 utilizing a set-top box 12 with enhanced functionality and control capabilities being employed within a hospitality lodging establishment. The hospitality lodging establishment or, more generally, hospitality property, may be a furnished multi-family residence, dormitory, lodging establishment, hotel, hospital, or other multi-unit environment. As shown, by way of example and not by way of limitation, the hospitality environment is depicted as the hotel H having various rooms, including room R and back of the house operations O. The set-top box 12 includes a housing 14 and is communicatively disposed with various amenities associated with the hospitality environment or hotel H, including a display 16 having a screen 18 and a speaker 19, which may be separate from the display 16 or fully integrated therewith. Set-top boxes, like the set-top box 12, may be deployed throughout the rooms R of the hotel H.

As shown, in one embodiment, within the room R, the system 10 includes the set-top box 12 and the display 16 having the screen 18. The display 16 may be a television or any form of electronic visual display device. A connection, which is depicted as an HDMI connection 20, connects the set-top box 12 to the display 16. Other connections include a power cable 22 coupling the set-top box 12 to a power source, a coaxial cable 24 coupling the set-top box 12 to an external cable source, and a category five (Cat 5) cable 26 coupling the set-top box 12 to an external pay-per-view source at a hotel or other lodging establishment, for example. As shown, the set-top box 12 may include a dongle providing particular technology and functionality extensions thereto. That is, the set-top box 12 may be a set-top box-dongle combination in one embodiment. More generally, it should be appreciated that the cabling connected to the set-top box 12 will depend on the environment and application and the cabling connections presented in FIG. 1 are depicted for illustrative purposes. Further, it should be appreciated that the positioning of the set-top box 12 will vary depending on environment and application and, with certain functionality, the set-top box 12 may be placed more discretely behind the display 16.

Room control 34 represents control of various amenities associated with a user's stay in a lodging establishment. The various amenities may include lights 36, a thermostat, shades, and a doorbell/do not disturb designation 38. The set-top box 12 is communicatively disposed with these various amenities, which may also include a CD/DVD player, a radio tuner, and a hospitality suite 40, which represents a set of services such as check in/check out, maid service 42, spa, room service, and front desk 44.

In operation, the set-top box 12 receives a source signal from an external source and forwards a fully tuned audiovisual signal to the display 16 and the speaker 19 based on the source signal, which may be received from the coaxial cable 24. The set-top box 12 generates a processed audio signal by analyzing an external audio signal, which is a combination of sound S₁ from the speaker 19 and speech S₂ from the guest G, received at set-top box 12 against an internal audio source signal component of the source signal. The internal audio source signal component of the source signal represents the display-speaker sound output signal and Sound S₁. The processed audio signal isolates the speech S₂, which may be analyzed by the set-top box 12 to determine the presence of a command.

By way of example, remote control functionality may be provided by a spoken sequence of words to send a command signal to the display, execute a program via the Internet, or control an amenity associated with a user's stay in a lodging establishment, for example. As shown in FIG. 1, by way of example, guest G speaks spoken words S₂ which are received by the set-top box 12 and translated into a command to change the channel from program P₁ to program P₂, which includes sound S₃. The set-top box 12 utilizes the internal audio source signal component of the source signal to analyze the ambient sound S_{A} to isolate the sound S₂ from the sound S₁.

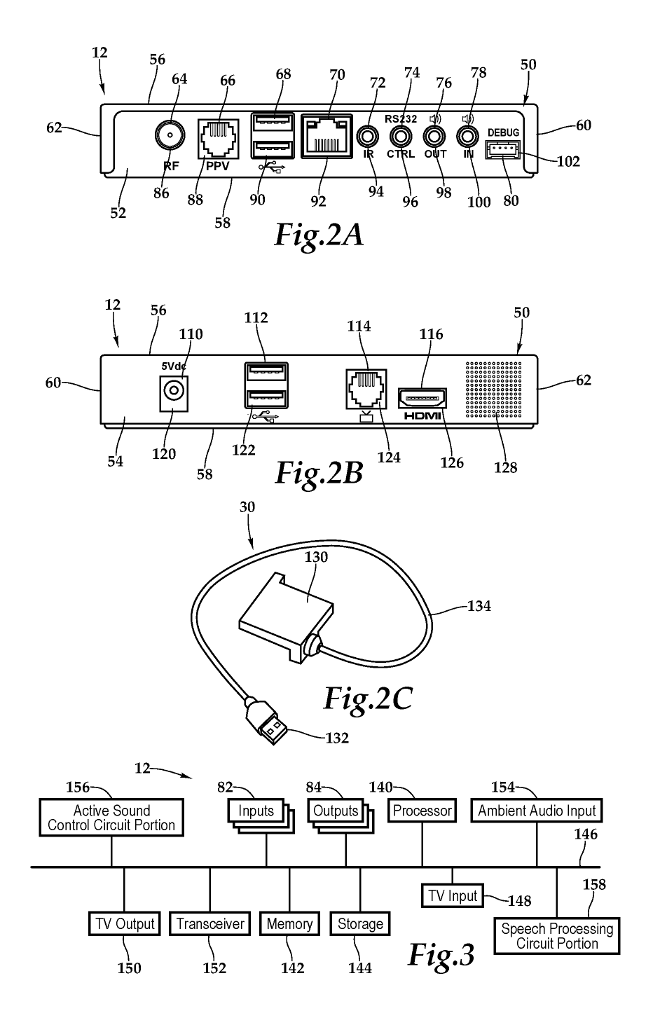

Referring to FIG. 2A, FIG. 2B, FIG. 2C, and FIG. 3, as used herein, set-top boxes, back boxes and set-top/back boxes may be discussed as set-top boxes. By way of example, the set-top box 12 may be a set-top unit that is an information appliance device that generally contains set-top box functionality including having a television-tuner input and displays output through a connection to a display or television set and an external source of signal, turning by way of tuning the source signal into content in a form that can then be displayed on the television screen or other display device. Such set-top boxes are used in cable television, satellite television, and over-the-air television systems, for example.

The set-top box 12 includes a housing 14 having a cover 50 having a rear wall 52, front wall 54, top wall 56, bottom base 58, and two sidewalls 60, 62. It should be appreciated that front wall, rear wall, and side wall are relative terms used for descriptive purposes and the orientation and the nomenclature of the walls may vary depending on application. The front wall includes various ports, ports 64, 66, 68, 70, 72, 74, 76, 78, and 80 that provide interfaces for various interfaces, including inputs and outputs. In one implementation, as illustrated, the ports 64 through 80 include inputs 82 and outputs 84 and, more particularly, an RF input 86, a RJ-45 input 88, universal serial bus (USB) input/outputs 90, an Ethernet category 5 (Cat 5) coupling 92, an internal reset 94, an RS232 control 96, an audio out 98, an audio in 100, and a debug/maintenance port 102. The front wall 54 also includes various inputs 82 and outputs 84. More particularly, ports 110, 112, 114, and 116 include a 5V dc power connection 120, USB inputs/outputs 122, an RJ-45 coupling 124, an HDMI port 126, and a microphone 128. It should be appreciated that the configuration of ports may vary with the set-top box depending on application and context. As previously alluded to, the housing 14 may include a housing-dongle combination including, with respect to the dongle 30, a unit 130 having a cable 134 with a set-top box connector 132 for selectively coupling with the set-top box 12.

Within the housing 14, a processor 140, memory 142, storage 144, the inputs 82, and the outputs 84 are interconnected by a bus architecture 146 within a mounting architecture. It should be understood that the processor 140, memory 142, storage 144, the inputs 82, and the outputs 84 may be entirely contained within the housing 14 or the housing-dongle combination. The processor 140 may process instructions for execution within the computing device, including instructions stored in the memory 142 or in storage 144. The memory 142 stores information within the computing device. In one implementation, the memory 142 is a volatile memory unit or units. In another implementation, the memory 142 is a non-volatile memory unit or units. Storage 144 provides capacity that is capable of providing mass storage for the set-top box 12. Various inputs 82 and outputs 84 provide connections to and from the computing device, wherein the inputs 82 are the signals or data received by the set-top box 12, and the outputs 84 are the signals or data sent from the set-top box 12.

A television content signal input 148 and a television output 150 are also secured in the housing 14 in order to receive content from a source in the hospitality property and forward the content, including external content such as cable and satellite and pay-per-view (PPV) programming, to the television located within the hotel room.

A transceiver 152 is associated with the set-top box 12 and communicatively disposed with the bus 146. As shown the transceiver 152 may be internal, external, or a combination thereof to the housing. Further, the transceiver 152 may be a transmitter/receiver, receiver, or an antenna for example. Communication between various amenities in the hotel room and the set-top box 12 may be enabled by a variety of wireless methodologies employed by the transceiver 152, including 802.11, 3G, 4G, Edge, WiFi, ZigBee, near field communications (NFC), Bluetooth low energy and Bluetooth, for example. Also, infrared (IR) may be utilized.

An ambient audio input 154, which is coupled to microphone 128, an active sound control circuit portion 156, and a speech processing circuit portion 158 are also secured in the housing 14. Moreover, the ambient audio input 154, the active sound control circuit portion 156, and the speech processing circuit portion 158 are interconnected by the bus architecture 146 within the aforementioned mounting architecture. Within this architecture, the active sound control circuit portion 156 may be at least partially integrated with the processor 140. Similarly, the speech processing circuit portion 158 may be at least partially integrated with the processor 140.

The memory 142 and storage 144 are accessible to the processor 140 and include processor-executable instructions that, when executed, cause the processor 140 to execute a series of operations. The processor-executable instructions cause the processor to receive an external audio signal at the audio input unit and generate a sound cancellation signal based on the audio source signal component of the source signal. The sound cancellation signal, which represents the sound output of the display and speaker, may be generated using the television content signal input 148 or the television output 150, for example, in conjunction with the active sound control circuit portion 156. The processor-executable instructions may cause the processor to receive a volume feedback signal from the display 16 and the speaker 19 and utilize the volume feedback signal to generate the sound cancellation signal or generate the processed audio signal, for example. The processor-executable instructions then cause the processor to utilize the active sound control circuit portion 156 to generate a processed audio signal by analyzing the external audio signal against the audio source signal component of the source signal. As a result, the processor-executable instructions may reduce or cancel the audio source signal component within the ambient sound signal to isolate any speech present.

The memory 142 may include processor-executable instructions that, when executed, further cause the processor to utilize the speech processing circuit portion 158 to evaluate the processed audio signal for a spoken sequence of words to assign a meaning to the spoken sequence of words, and based on the assigned meaning, generate a command signal. The command signal may relate to treating the spoken sequence of words as a voice command for execution on the Internet or remote control of a display or control of an amenity, for example.

With respect to controlling the display 16, the processor 140 may be caused to evaluate the spoken sequence of words to assign a meaning to the spoken sequence of words and then generate a command signal, which is sent to the display. With respect to amenity control, the memory 142 includes processor-executable instructions that, when executed cause the processor to be responsive to evaluating the spoken sequence of words, send a command to the particular amenity. A configuration profile is associated with the memory 142 and processor-executable instructions that enables the set-top box 12 to control multiple proximate amenities related to a user's stay in a lodging establishment in a multi-room environment, including the particular amenity to be controlled. Thus, the systems and methods disclosed herein may enable users to use existing speech as a control to control a display and associated speaker or speakers or amenity via a set-top box. Further, the systems and methods disclosed herein may enable users to use existing speech to execute a command relative to the Internet. Therefore the systems and methods presented herein avoid the need for additional or expensive high functionality remote controls.

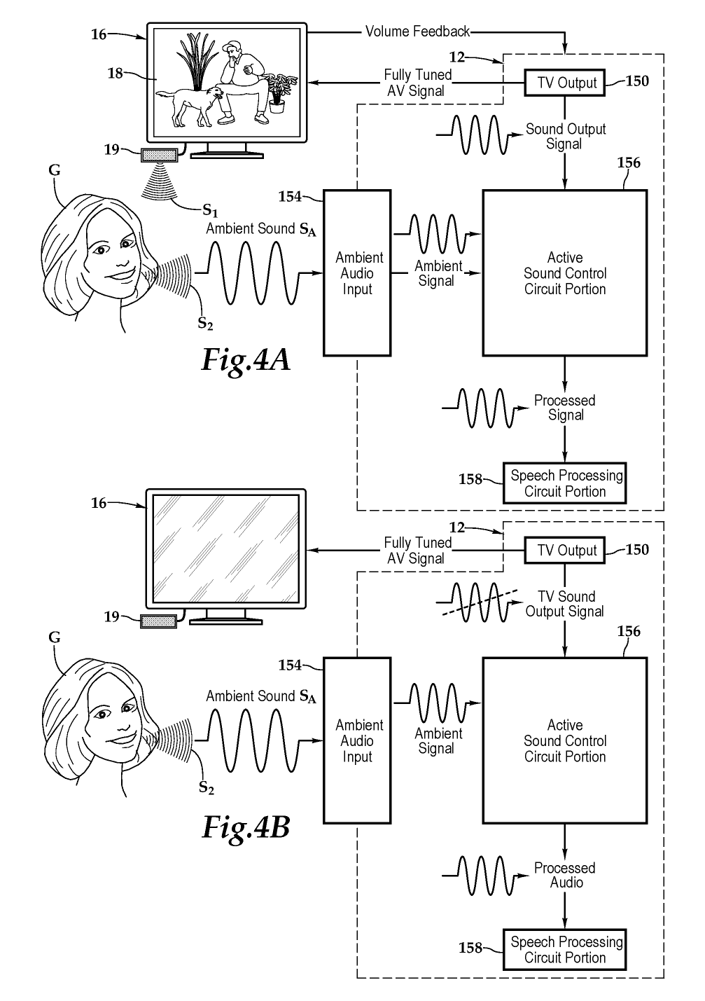

Referring now to FIG. 4A and FIG. 4B, one operational embodiment of the set-top box 12 is presented, which focuses on certain components depicted in FIG. 3. Within the busing architecture discussed in FIG. 3, the television output 150, the ambient audio input 154, the active sound control circuit portion 156, and the speech processing circuit portion 158 are interconnected. As previously discussed, the television input 148 receives a source signal from an external source. The source signal may include a visual source signal component and an audio source signal component. Based on the source signal, the television output forwards a fully tuned audiovisual signal to the display 16 and the speaker 19.

The active sound control circuit portion 156 may include analog circuits, digital processing circuits, and combinations thereof. The active sound control circuit portion 156 may include a circuit portion to digitize the external audio signal prior to applying digital signal processing. The active sound control circuit portion 156 may receive the ambient sound S_{A} in order to remove at least a portion of the fully tuned audiovisual signal by way of a noise cancellation stage or noise cancellation loop. The active sound control circuit portion 156 may also receive a volume feedback signal, including volume, from the display 16 and the speaker 19 to further eliminate the TV sound S₁ from the ambient sound S_{A} to isolate the speech S₂. As such, in one aspect, the set-top box 12 may generate a TV sound output signal representative of the sound portion of fully tuned AV signal sent to the display 16 and speaker 19. The active sound control circuit portion 156 may receive the ambient signal indicative of the ambient sound and the TV sound output signal, which represents the audio source signal component of the fully tuned audiovisual signal, in order to remove at least a portion of the TV sound conveyed in the ambient sound. As shown in FIG. 4A, the display 16 and the speaker 19 are active and the display output signal is provided by the television output 150 to offset the TV sound S₁ and isolate the speech S₂ from the ambient sound S_{A}. On the other hand, in FIG. 4B, the display and the speaker are not active and the display-speaker output signal indicates no sound from the display 16 and the speaker 19.

Continuing to refer to both FIG. 4A and FIG. 4B, as shown, the active sound control circuit portion 156 generates a processed audio signal by analyzing the ambient signal and display-speaker sound output signal. The processed signal is provided to the speech processing circuit portion 158. In one example, the active sound control circuit portion 156 can reverse at least a portion of the ambient sound S_{A} that is associated with sound S₁, and can generate or otherwise compose an output audio signal that can include the reversed ambient audio. Accordingly, in one aspect, the output processed signal can convey audio data that substantially lacks the ambient TV sound S₁ received as part of the ambient sound S_{A}.

The speech processing circuit portion 158 receives the processed audio signal to detect, for example, key words and audible commands and any additional audio captured in the recording, and processes the processed audio signal to determine whether the recording corresponds to an utterance of key words as well as any audible command that should be disregarded as being inadvertent. The speech processing circuit portion 158 may access the storage 144 of the set-top box 12 shown in FIG. 3 and compare the captured audio within the processed signal to the stored utterances, whether audible to humans or inaudible to humans, and audio sequences using audio comparison techniques.

To process the recording/captured key words and audible commands, the speech processing circuit portion 158 may employ audio fingerprinting techniques and other speech/audio comparison techniques. For example, speech processing circuit portion 158 may use audio or acoustic fingerprinting techniques. In this aspect, a digital summary of audio including an inadvertent key word or audible command may be generated based on frequency, intensity, time, and other parameters of the audio. This digital summary may then be stored and compared to audio or acoustic fingerprints of captured audio including the key words and/or audible command. In one embodiment, the speech processing circuit portion 158 may include speech recognition capabilities to convert audio to text. The set-top box 12 may compare text resulting from the captured audio to stored text.

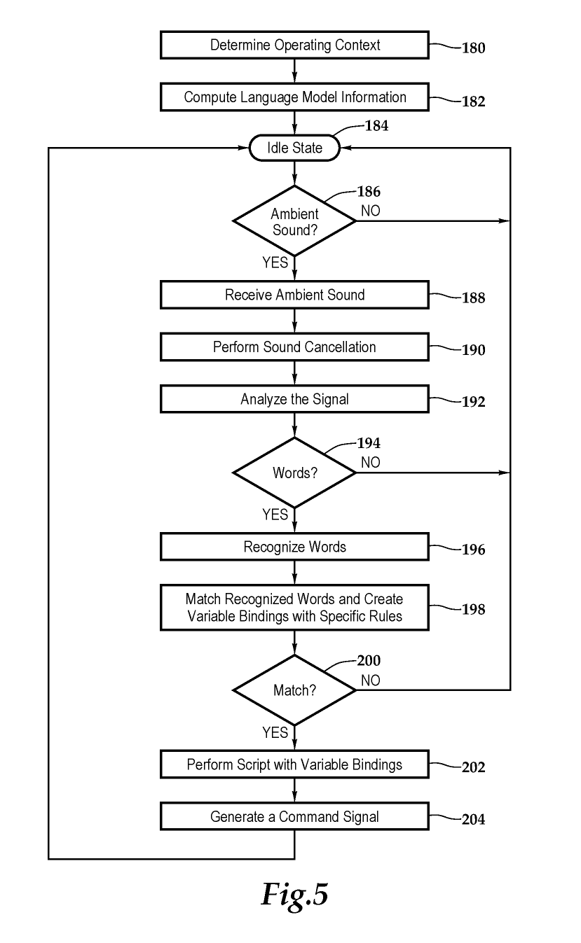

Referring now to FIG. 5, one embodiment of a process flow diagram relating to a method for utilizing set-top boxes with enhanced functionality and controls that address and enhance the content typically received from an external signal source and provided to a display is illustrated. More specifically, with reference to blocks 180 and 182, a current operating context is determined by examining the instructions provided to the proximate wireless-enabled interactive programmable device. With this context, language model information is determined so that the scope of vocabulary search is defined such that in subsequent steps a determination may be made if any uttered speech matches. At block 184, the language recognition processing is in an idle state prior to obtaining words. As shown at decision block 186, the language recognition processing remains in an idle state until ambient sound is detected.

At block 188, ambient sound is received and at block 190, a sound cancellation signal is generated based on the audio source signal component of a source signal received at the set-top box. The sound cancellation is performed to isolate the sound that is not originating from the display and speakers as provided by the set-top box. If words are present then the methodology advances to block 196. On the other hand, if no words are present then the methodology returns to block 184. At block 196, the signal is analyzed for speech. Speech rules which match the recognized utterance are determined. The process of matching a speech rule to an utterance also produces a set of variable bindings, which represents the meaning of various phrases in the recognized utterance. At decision block 198, the speech rules in the system are compared to the guest's utterance to determine if a match is present. At block 192, the signal is analyzed for speech. At decision block 194, if a match is not present, then the process returns to the idle state at block 184. On the other hand, if a match exists, then the process advances to block 202, where a script associated with the speech rules and the variable bindings from the previous steps is executed. The script may mimic the execution of a virtual button on the proximate wireless-enabled interactive programmable device, in one embodiment. The methodology then advances to block 204 where the corresponding command signal is generated.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A set-top box comprising:
a housing securing a television input, a television output, a processor, memory, storage, an audio input unit, and an active sound control circuit portion therein;
a busing architecture communicatively interconnecting the television input, the television output, the processor, the memory, the storage, the audio input unit, and the active sound control circuit portion;
the television input configured to receive a source signal from an external source, the source signal having a visual source signal component and an audio source signal component;
the television output configured to forward a fully tuned audiovisual signal to a display and a speaker based on the source signal; and
the memory accessible to the processor, the memory including processor-executable instructions that, when executed, cause the processor to:
receive an external audio signal at the audio input unit,
generate a sound cancellation signal based on the audio source signal component of the source signal, and
utilize the active sound control circuit portion to generate a processed audio signal by analyzing the external audio signal against the audio source signal component of the source signal.

2. The set-top box as recited in claim 1, wherein the active sound control circuit portion further comprises circuits selected from the group consisting of analog circuits, digital processing circuits, and combinations thereof.

3. The set-top box as recited in claim 1, wherein the active sound control circuit portion further comprises a circuit portion to digitize the external audio signal prior to applying digital signal processing.

4. The set-top box as recited in claim 1, wherein the processor-executable instructions that, when executed, cause the processor to utilize the active sound control circuit portion to generate a processed audio signal by analyzing the external audio signal against the audio source signal component of the source signal further cause the processor to reduce the audio source signal component.

5. The set-top box as recited in claim 1, wherein the processor-executable instructions that, when executed, cause the processor to utilize the active sound control circuit portion to generate a processed audio signal by analyzing the external audio signal against the audio source signal component of the source signal further cause the processor to cancel the audio source signal component.

6. The set-top box as recited in claim 1, wherein the processor-executable instructions further comprise processor-executable instructions, when executed, cause the processor to:
receive a volume feedback signal indicative of a volume of the fully tuned audiovisual signal at the display and the speaker; and
generate the processed audio signal by utilizing the volume feedback signal.

7. The set-top box as recited in claim 1, wherein the external audio signal further comprises the fully tuned audiovisual signal from the speaker.

8. The set-top box as recited in claim 1, wherein the external audio signal further comprises speech.

9. The set-top box as recited in claim 1, wherein the memory includes processor-executable instructions that, when executed, further cause the processor to:
evaluate the processed audio signal for a spoken sequence of words to assign a meaning to the spoken sequence of words,
based on the assigned meaning, generate a command signal.

10. The set-top box as recited in claim 8, wherein the command signal provides remote control of the television.

11. The set-top box as recited in claim 1, wherein the memory includes processor-executable instructions that, when executed cause the processor to:
responsive to evaluating the spoken sequence of words, send a command to the particular amenity; and
a configuration profile associated with the memory and processor-executable instructions that enables the set-top box to control a plurality of proximate amenities in a multi-room environment, the plurality of proximate amenities including the particular amenity, the plurality of proximate amenities being associated with a user's stay in a lodging environment.

12. The set-top box as recited in claim 11, wherein the plurality of proximate amenities is selected from the group of amenities consisting of lights, thermostats, shades, and doorbell/do not disturb designations.

13. The set-top box as recited in claim 1, wherein the memory includes processor-executable instructions that, when executed cause the processor to:
responsive to evaluating the spoken sequence of words, treat the spoken sequence of words as a voice command for execution on the Internet.

14. The set-top box as recited in claim 1, wherein the housing further comprises a housing-dongle combination securing the television input, the television output, the processor, memory, storage, and the active sound control circuit portion therewith.

15. The set-top box as recited in claim 14, wherein the processor and the memory are distributed through the housing-dongle combination.

16. The set-top box as recited in claim 1, wherein the display is selected from the group consisting of televisions and electronic visual display devices.

17. The set-top box as recited in claim 1, wherein the display and the speaker are at least partially integrated.

18. The set-top box as recited in claim 1, wherein the display and the speaker are separate components.

19. A set-top box comprising:
a housing securing a television input, a television output, a processor, memory, storage, an audio input unit, and an active sound control circuit portion therein;
a busing architecture communicatively interconnecting the television input, the television output, the processor, the memory, the storage, the audio input unit, and the active sound control circuit portion;
the television input configured to receive a source signal from an external source, the source signal having a visual source signal component and an audio source signal component;
the television output configured to forward a fully tuned audiovisual signal to a display and speaker based on the source signal; and
the memory accessible to the processor, the memory including processor-executable instructions that, when executed, cause the processor to:
receive an external audio signal at the audio input unit,
generate a sound cancellation signal based on the audio source signal component of the source signal,
utilize the active sound control circuit portion to generate a processed audio signal by analyzing the external audio signal against the audio source signal component of the source signal, and
evaluate the processed audio signal for a spoken sequence of words to assign a meaning to the spoken sequence of words.

20. A set-top box comprising:
a housing securing a television input, a television output, a processor, memory, storage, an audio input unit, an active sound control circuit portion therein, and a speech processing circuit portion;
a busing architecture communicatively interconnecting the television input, the television output, the processor, the memory, the storage, the audio input unit, the active sound control circuit portion, and the speech processing circuit portion;
the television input configured to receive a source signal from an external source, the source signal having a visual source signal component and an audio source signal component;
the television output configured to forward a fully tuned audiovisual signal to a display and speaker based on the source signal; and
the memory accessible to the processor, the memory including processor-executable instructions that, when executed, cause the processor to:
receive an external audio signal at the audio input unit, the external audio signal includes the fully tuned audiovisual signal from the speaker and speech,
receive a volume feedback signal indicative of a volume of the fully tuned audiovisual signal at the display and the speaker,
generate a sound cancellation signal based on the audio source signal component of the source signal,
utilize the active sound control circuit portion to generate a processed audio signal by utilizing the volume feedback signal and analyzing the external audio signal against the audio source signal component of the source signal to at least reduce the fully tuned audiovisual signal from the speaker, and
utilize the speech processing circuit portion to evaluate the processed audio signal for a spoken sequence of words to assign a meaning to the spoken sequence of words.
